(19) United States
(12) Patent Application Publication
(10) Pub. No.: US 2013/0011811 A1
(43) Pub. Date: Jan. 10, 2013

(54) IMPLANT ENDO-OSSEUX ET PROCEDE DE SA FABRICATION

(75) Inventors: Jeannine Gourlaouen-Preissler, Montreuil (FR); Bertrand Busson, Rueil Malmaison (FR)

(73) Assignee: ZDA-ZIRCONIA DEVELOPPEMENT & APPLICATIONS, Laval Cedex (FR)

(21) Appl. No.: 13/512,410

(22) PCT Filed: Nov. 29, 2010
(86) PCT No.: PCT/EP2010/068431

§ 371 Date: Sep. 24, 2012

(30) Foreign Application Priority Data
Nov. 27, 2009 (FR) 0958461
Dec. 21, 2009 (FR) 0959327
Nov. 22, 2010 (FR) 1059598

(51) Int. Cl. A61C 8/00; A61C 13/083

(52) U.S. Cl. 433/173; 433/201.1

(57) ABSTRACT

An endosseous implant, in particular for an implantation in a periodontal tissue, the implant: a) being made of a sintered ceramic material; b) including a surface capable of being implanted in a recipient tissue; and c) the surface including a raised texture analogous to the texture of the surface of the recipient tissue. An advantageous method for manufacturing such an implant is disclosed.

The invention relates to an endosseous implant made of ceramics for medical or veterinary applications. More particularly the invention relates to such a nonmetal implant, preferentially made of a ceramic material.

Endosseous implants known from prior art, in particular those for a periodontal implantation, consist of metallic materials, generally containing titanium. These prior art implants are subjected to various surface treatments aiming at conferring a surface finish promoting their osseointegration after implantation in the bone tissue. These surface finishes are obtained either by coating the implant, or a zone of this implant, in particular by projection, with a layer of a material exhibiting a surface texture and physicochemical characteristics promoting cell colonization by osteoblasts of the surface thus coated. Alternatively, such a surface finish can be obtained by machining, i.e. by material removal, of the whole or part of surface of said implant, for example, by machining with a cutting tool, a laser or by abrasion by using sanding or shot-blasting techniques.

In addition to the fact that the techniques using material removal are hardly applicable to an implant made of a very hard ceramic material, in particular because of the lack of ductility of such a material which does not allow the formation of a chip by plastic flow of the material; the surface texture is very dependent on the nature of the process and on the material-process couple. Thus, the optimization of the surface finish conditions is performed through experimental designs and clinical trials aiming, for example, at correlating characteristic features of the surface thus obtained, with the rate of osseointegration of the implant comprising such a surface. These trials are long lasting, expensive and once the conditions appearing to be optimal are obtained, it still remains to determine the parameters of the surface treatment to control so that the result is reproducible within the framework of a production, more particularly in mass production.

In order to solve the disadvantages of prior art, the invention proposes an endosseous implant, in particular for an implantation in a periodontal tissue remarkable in that:

a. it is made of a sintered ceramic material;

b. it comprises a surface suitable for being implanted in a recipient tissue and that said surface includes a raised texture analogous to the texture of the surface of the recipient tissue.

In all of the text, a surface texture indicates the form of a raised pattern of a surface designated as S-L according to the ISO 25178 standard, i.e., raised patterns whose order of magnitude is within the roughness parameters and waviness of a surface of any macroscopic form, virtually reduced to a flat surface by a filter according to the IS016610 standard. A surface finish qualifies such a surface by a parameter according to the ISO 25178 standard.

The term “analogous” shall be here understood in the sense that the surface texture of the implant reproduces a network of substantially homothetic geometrical patterns, the geometry and the dimensions of these patterns being comparable with the patterns of the surface texture of the recipient tissue, without being, strictly speaking, identical thereto.

Thus, the implant according to the invention reproduces not only the surface finish of the implantation tissue but exhibits texture patterns whose form and dimension are adapted to the recipient tissue, which promotes the cell colonization of said implant surface.

This result is obtained in a reproducible way and in mass production through, in particular, the nature of the implant, made of a sintered ceramic. For this purpose, the invention also relates to a manufacturing method for such an implant, said method comprising the steps consisting in:

a. etching on the wall of the imprint of a mould, a network of patterns forming a surface texture, the dimensions of the said patterns taking into account of the shrinking of the ceramic constituting the implant during sintering;

b. injecting a ceramic powder mixed with a binder in said mould so as to obtain a rough shape of the part in the green state;

c. sintering said rough part so as to obtain the finished part.

Thus the method according to the invention takes advantage from the very important shrinkage observed during the sintering of the ceramic and makes it possible to etch the mould with a much larger pattern in dimensions, than it will be on the sintered implant, thus opening the possibility of using etching technologies which would not be usable at the scale of the patterns seen on the implant. In addition, the mould can advantageously be made of a metallic material which exhibits a ductile response to the material removal, thus authorizing the use of etching techniques which could not be used on the ceramic implant itself.

The invention can be implemented according to the advantageous embodiments exposed hereafter, that can be considered individually or according to any technically effective combination.

Advantageously, the method according to the invention comprises moreover the steps consisting in:

d. obtainining an image of the surface texture of the surface of a tissue similar to that in which the implant shall be implanted;

e. applying to this image a scale factor according to the shrinkage during the sintering of the ceramic constituting the implant;

f. etching the aforementioned image scaled according to this factor on a wall of the imprint of a mould.

Thus the surface texture reproduced on the implant is the nearest as possible to that of the recipient tissue.

The “similar” term is, in this text, equivalent to “compared to” i.e. it stands, in this context, as the image of a tissue of the same category but not belonging necessarily to the same patient or to the same animal than the tissue in which the implant is set up.

According to a first embodiment of the implant according to the invention, it comprises a surface suitable for being implanted in an alveolar bone tissue said surface including a texture consisting in an alveolar geometry patterns whose average width lies between 8 μm and 15 μm. Thus, the alveolar cavities are colonized by the osseous cells of the tissue after implantation, and the surface relief ensures a mechanical fixing of the implant in the alveolar bone by osseointegration. Contrary to a machining groove, which frequently constitutes the surface texture pattern of a machined metallic implant, each alveolar cavity of the implantation surface cooperating with the recipient tissue constitutes a closed microvolume without direct communication with the neighboring texture patterns. Thus, the surface texture of the implant does not constitute an easy way allowing bacteria, following the surface of the implant, to be introduced deeply into the recipient tissue. Each of these closed microvolumes constitutes individually a potential anchoring of the implant in the recipient tissue.

In all text 1 μm is equal to 10⁻⁶ meters.

Advantageously also, the surface finish Sz of the surface texture of the surface suitable for being implanted in the alveolar bone tissue lies between 1 μm and 3 μm. This value of the surface finish, which corresponds roughly to the depth of the alveolar cavities of the texture, is optimal for the cell colonization in this type of tissue and for the osseointegration of the implant in thereto.

The width and depth combination of the alveolar cavity is thus adapted to the mechanical characteristics of the recipient tissue so as to fulfill the mechanical anchoring function.

According to particularly advantageous an embodiment of this first variant, the surface suitable for being implanted in the alveolar bone tissue includes a texture reproducing the surface texture of a tissue similar to that of the implantation. Thus the surface texture is the closest to the texture of the tissue in which the implant according to the invention is implanted.

According to a second embodiment of the implant according to the invention, this one comprises a surface suitable for being implanted in a cortical bone tissue, said surface including a texture consisting in a pattern of an alveolar geometry whose average width lies between 1.5 μm and 5 μm. Thus, in addition to the effect of promoting the osseointegration of the surface in the tissue, this surface relief ensures a strong mechanical fixing of the implant in the cortical bone after osseointegration, and consequently the mechanical stability of this one.

Advantageously also, the surface finish Sz of the surface texture of the surface suitable for being implanted in the cortical bone tissue lies between 0.1 μm and 0.5 μm. Thus the thickness of the osseointegration layer in the harder cortical bone, is lower than in the vascularized and more plastic alveolar bone. This reduced thickness makes it possible to better distribute the incompatibilities of elastic strain between the ceramic implant, whose elastic module is definitely higher than that of the bone tissue, and the cortical bone, while ensuring a mechanical anchoring of this one in the bone.

Advantageously the surface suitable for being implanted in the cortical bone tissue includes a texture replicating the surface texture of a tissue similar to that of the implantation tissue. Thus the osseointegration capacity is optimal.

In a third embodiment, the implant according to invention includes a surface adapted to be implanted in a soft connective tissue, in particular a gum tissue, said surface having a texture replicating the surface texture of a tissue similar to the implantation tissue. This surface texture promotes the regeneration of the soft connective tissue on the implant and thus the sealing of the osseous implantation of the aforesaid implant.

According to a particularly advantageous embodiment, the implant of the invention extends in a longitudinal direction and comprises a succession of longitudinal surfaces with different surface textures replicating textures similar to those tissues with which they come into contact during the in vivo implantation of said implant. This embodiment allows an optimal anchoring of the implant over all its length of tissue implantation.

Advantageously, the implant of the invention according to its first embodiment comprises a cylindrical body and the surface implantable in the alveolar bone is a threading comprising a cutting edge extending parallel to the cylinder axis so that said threading is self-tapping in the alveolar bone tissue. Thus, the cutting of the bone tissue by the cutting edge during the introduction of the implant into the aforementioned tissue, promotes, through a compaction effect, the intimate contact of this tissue with the sides of the threading: an advantageous way for the sealing of the implantation and the osseointegration of the implant surface.

According to an advantageous embodiment of the second variant of the implant of the invention, this one comprises an appreciably cylindrical body and the implantable surface in the cortical bone comprises a conical threading comprising at least one thread. This conical threading ensures a primary mechanical anchoring of the implant in the hard cortical bone.

Advantageously, the conicity of the threading of the implantable surface in the cortical bone lies between 0.02 and 0.1. This low conicity makes it possible to ensure a radial maintaining of the implant over all its implantation length in the cortical bone.

Advantageously, the thread of the cone-shaped threading is interrupted at each turn. This provision prevents bacteria, following the surface of the thread, of penetrating deeply in the tissue implantation.

Advantageously, the thread interruption surface comprises a cutting edge. Thus, the part of the implant implantable in the cortical bone is self-tapping, taking advantage of the ceramic nature, thus very hard, of the implant.

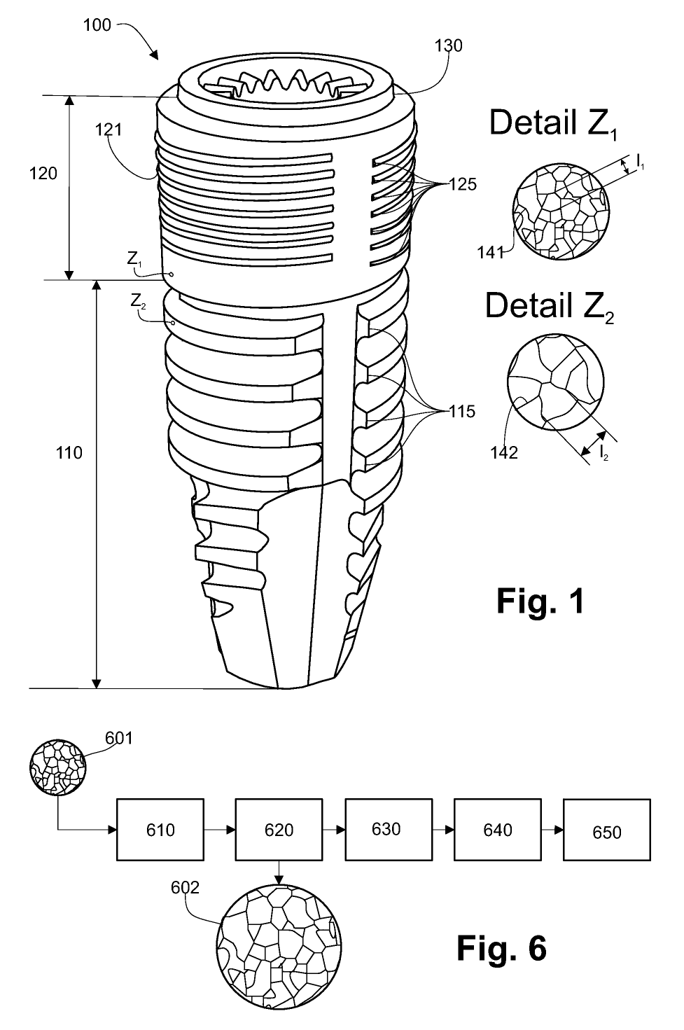

The invention will be more specifically described by its preferred, thus non limiting, embodiments, outlined below and in FIGS. 1 to 6, in which:

FIG. 1 represents in perspective seen from the front, an implant body, according to an example embodiment of the invention as well as two detail views of the surface textures of such an implant;

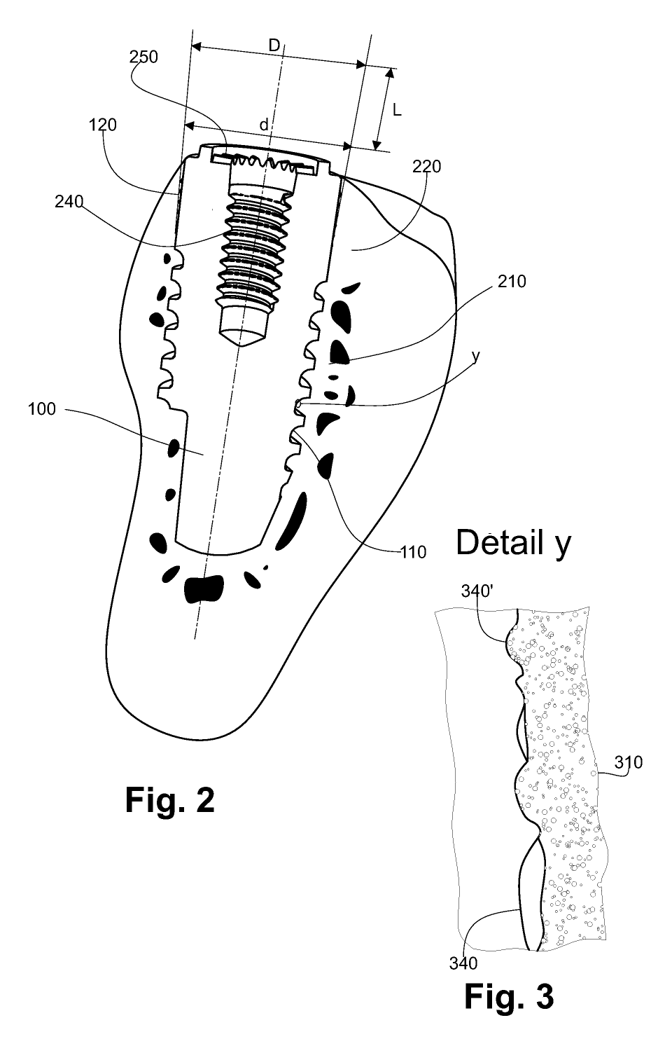

FIG. 2 shows in perspective in section seen from the front, an implant according to an example embodiment of the invention in a mandibular implantation;

FIG. 3 is a font view and highly magnified section of the contact between the textured surface of an implant according to an example embodiment of the invention, and a recipient bone tissue;

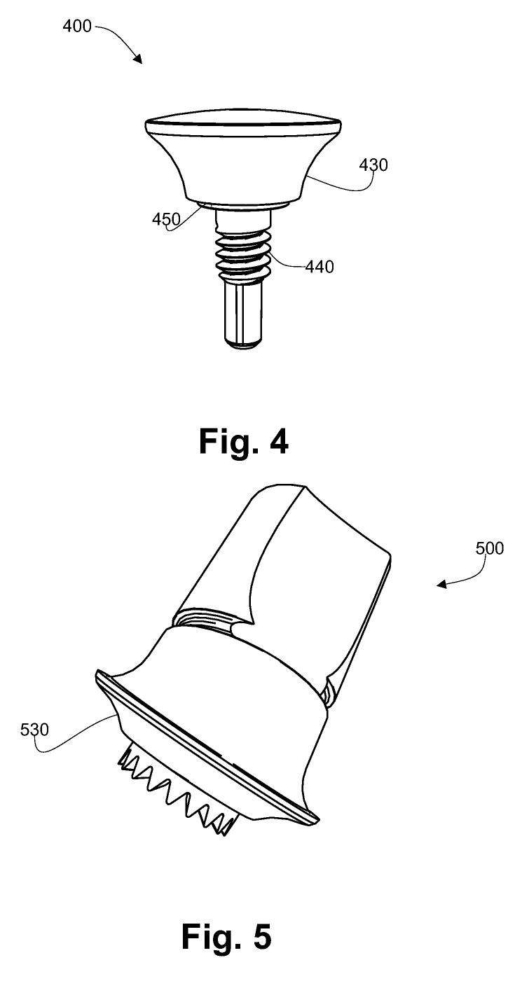

FIG. 4 represents according to a front view in perspective an example embodiment of a healing collar adaptable on an implant according to the invention;

FIG. 5 is a perspective view seen from the bottom of an example embodiment of an abutment adaptable on an implant according to the invention;

and FIG. 6 is a flowchart describing the sequence of steps according to an embodiment of the method according to the invention.

FIG. 1, according to an example embodiment of an implant (100) according of the invention, more particularly suitable for a periodontal implantation, this one comprises an appreciably cylindrical body, whose surface in contact with the recipients tissues comprises three longitudinal sections.

A first section (110) suitable for an implantation in the alveolar bone, comprises a threading with a broad pitch. This threading is interrupted at each turn and each interruption of this thread defines a cutting edge (115). A second section (120) suitable for an implantation in the cortical bone comprises a cone-shaped micro-threading (121), said micro-threading being also interrupted at each turn, each interruption constituting a cutting edge (125). Finally, a third section (130) suitable for being implanted in the gum.

The surface of the first section (110) comprises a surface texture (Z2 detail) consisting of alveolar cavities (142) with a closed outline whose width L2 lies between 8 pm and 15 μm.

Z2 detail, the contours of the alveolar cavities (142) are points reliefs protruding from the surface (110) of the implant, the inside of the cavities (142) being recessed. The depth of the alveolar cavities lies between 1 μm and 3 μm, so that the surface finish Sz of this surface (110) appreciably lies between these values.

The surface of the second section (120) comprises a surface texture (detail Z1) consisting of alveolar cavities (141) with a closed outline whose width L1 lies between 1.5 μm and 5 μm for a depth ranging between 0.1 μm and 0.5 μm. As for the first section (110), the contour of the alveolar cavities is protruding and the interior of the alveolar cavities (141) is recessed.

The implant (100) is made out of ceramic, preferentially of zirconium dioxide (ZrO2), usually called zirconia, and more particularly of quadratic zirconia (ZrO2/Y2O3) stabilized with yttrium oxide, this last composition offering an optimal resistance to bending and cracking.

FIG. 2, according to an example of application of the implant of the invention, suitable for a periodontal implantation, the cone-shaped micro-threading of the part (120) of the implant (100) implanted in the cortical bone (220), exhibits a conicity ranging between 0.02 and 0.1, which gives an angle at the tip of the cone ranging between 1.15° and 6°. The conicity is defined by the ratio (D-d)/L, i.e. the variation of the diameter measured at the thread crest over a given length L.

FIG. 3, the osseointegration is achieved by the colonization of the alveolar cavities. (340) of the surface of the implant by the cells of the recipient tissue (310). Each alveolar cavity thus colonized (340′) being of a closed outline, constitutes, on an individual basis, a mechanical anchoring of the implant.

Coming back to FIG. 2, according to a particularly advantageous embodiment, the implant of the invention comprises an internal threading (240) and a fixture interface (250) suitable for receiving various suprastructures, such as a pillar, an abutment or a healing collar. Advantageously these suprastructures are also made of a sintered ceramic material, preferentially of quadratic yttria-stabilized zirconia. These suprastructures can advantageously comprise surface textures similar to the surface texture of the recipient tissue in which they are implanted.

FIG. 4, according to an example embodiment, a healing collar (400) adaptable as a suprastructure on the body of the implant (100) comprises a threading (440), suitable for being screwed in the interior tapping (240) of the body of the implant, and a bearing surface (450), suitable for centering and abuting on the interface of fixture (250) of the aforesaid body of the implant (100). This healing collar is made of a sintered ceramic material and is produced according to the method according to the invention. It comprises a cicatrization surface (430) which is in contact with the gum after the set-up of this collar on the body of the implant (100) implanted in the bone tissue. Advantageously, this cicatrization surface comprises a surface texture similar to that of the gum tissue, similar to the external surface texture of the higher section (130) of the implant body. This surface texture promotes the cicatrization of the gum on the aforementioned cicatrization surface (430), allowing the later disassembling of this collar without bleeding.

FIG. 5, the abutment (500) allows the set-up of a crown. It has a bottom surface (530) which is embedded into the gum. This surface is of the same form as the cicatrization surface (430) of the healing collar (400). Advantageously, the surface (530) of the abutment comprises a surface texture similar to the texture of the gum tissue.

FIG. 6, the invention also relates to a method for the manufacturing of the body (100) or of a suprastructure (400, 500) of an endosseous implant made of zirconia. According to an example embodiment, the method comprises a first step (610) consisting in obtaining a representation, hereafter qualified as the image of the wished surface texture, in particular an image of the texture of a tissue similar to that of the recipient tissue. It is not necessarily the image of the recipient tissue but of that of a tissue similar to this one.

This image can be a simple photography (601), it can also consist of a numerical file resulting from a three-dimensional scan of the texture of the tissue by any method known from the person skilled in the art. In a second step (620), a scale factor is applied to this image. This homothety, or scale factor, is a function of the shrinkage of the ceramic during sintering. Depending on the starting image, the homothety can be two-dimensional, for example in the case of a photograph, or three-dimensional, in the case of a topographic scan of the surface. The factor of shrinking of the ceramic at the time of sintering can reach 50%, depending on the nature of the ceramic used, and of its porosity content in the green state. Thus on the image (602) thus magnified, the surface outlined by the contour of an alveolar cavity is 2 to 2.5 times more important than surface on the initial image (601), and in the case of a three-dimensional image, the volume of an alveolar cavity is 3 to 3.5 times more important than its initial volume. The application of the factor of homothety can be carried out by a digital processing of the image (601) when this one is in the form of a data file, it can also be realized in an analogical way, for example by an enlarging of the photographic image (601). According to a later etching step (630), this homothetic image is etched on a wall of the imprint of the mould used for the realization of the implant by injection. This mould is preferentially made out of steel and the etching can be carried out by traditional techniques of photoengraving, or techniques of micromachining in particular by laser. The mould thus engraved is used for the injection (640) of a ceramic paste in order to make an implant in a green state, which is sintered, during a sintering step (650), in order to confer to this one its final properties. The pressure injection of the ceramic paste in the mould ensures the faithful reproduction of the form of the print including the surface textures. The minimal size of the surface patterns which can be reproduced depends on the grain size of the ceramic. The yttria stabilized zirconia is particularly favorable from this point of view, because its grain size is lower than 0.5 μm. In addition to its other advantageous properties, known from the prior art, this material makes it possible consequently to reproduce finest surface textures, like those of the cortical bone, so as to ensure an optimal osseointegration of the implant.

The foregoing description shows clearly that the invention achieved the pursued goals, in particular it allows an economic realization of a ceramic implant having a fine surface texture consisting of alveolar cavities with closed contour, which promotes the osseointegration of said implant in a recipient tissue.

1. An endosseous implant, in particular for an implantation in a periodontal tissue, said implant:
a. being made of a sintered ceramic material;
b. comprising a surface capable of being implanted in a recipient tissue and said surface including a raised texture analogous to the texture of the surface of the recipient tissue.

2. A method for manufacturing an implant according to claim 1, comprising the steps consisting in:
a. etching on the wall of the imprint of a mould a network of patterns forming a surface texture, the dimensions of the said patterns taking into account of the shrinking of the ceramic constituting the implant during sintering;
b. injecting a ceramic powder mixed with a binder in said mould so as to obtain a rough shape of the part in the green state;
c. sintering said rough part so as to obtain the finished part.

3. The method according to claim 2, further comprising the steps of:
d. Obtaining an image of the surface texture of the surface of a tissue similar to that in which the implant shall be implanted;
e. Applying to this image a scale factor according to the shrinkage during the sintering of the ceramic constituting the implant;
f. Etching the aforementioned image, scaled according to this factor, on a wall of the imprint of the mould.

4. An implant according to claim 1, comprising a surface suitable to be implanted in an alveolar bone tissue, said surface comprising a texture made of patterns of an alveolar geometry whose average width (12) lies between 8 μm and 15 μm

5. An implant according to claim 4, wherein the surface quality Sz of the surface texture suitable for being implanted in an alveolar bone tissue lies between 1 μm and 3 μm.

6. An implant according to claim 5, wherein that surface suitable for being implanted in an alveolar bone tissue comprises a texture replicating the surface texture of a tissue similar to this implantation tissue.

7. An implant according to claim 1, comprising a surface suitable for being implanted in a cortical bone wherein the texture of this surface consists of patterns (141) of an alveolar geometry whose width (11) lies between 1.5 μm and 5 μm.

8. An implant according to claim 7, wherein the surface finish Sz of the surface texture of the surface suitable for being implanted in the cortical bone tissue lies between 0.1 μm and 0.5 μm.

9. An implant according to claim 8, wherein the surface suitable for being implanted in a cortical bone tissue comprises a texture replicating the surface texture of a tissue similar to this implantation tissue.

10. An implant according to claim 1, comprising a surface suitable for being implanted in a soft connective tissue, such as a gum tissue, wherein said surface comprises a texture replicating the surface texture of a tissue similar to this implantation tissue.

11. An implant according to claim 1, extending according to a longitudinal direction and comprising a longitudinal succession of surfaces comprising different surface textures, these surface textures replicating textures similar to those of the tissue with which they are in contact at the time of the in vivo implantation of the implant.

12. An implant according to claim 4, comprising a cylindrical body wherein the implantable surface in the alveolar bone is a threading comprising a cutting edge extending parallel to the axis of the cylinder so that said threading is self-tapping in the alveolar bone tissue.

13. An implant according to claim 7, comprising a cylindrical body wherein the surface implantable in the cortical bone comprises a cone-shaped threading comprising at least one thread.

14. An implant according to claim 13, where this thread of the cone-shaped threading is interrupted at each turn.

15. A implant according to claim 14, wherein the surface of interruption of the thread comprises a cutting edge.

16. An implant according to claim 13, wherein the conicity of the threading of the surface implantable in the cortical bone lies between 0.02 and 0.1.
